(19) United States
(12) Patent Application Publication
(10) Pub. No.: US 2022/0260213 A1
(43) Pub. Date: Aug. 18, 2022

(54) TANK DEVICE FOR STORING A GASEOUS MEDIUM

(71) Applicant: Robert Bosch GmbH, Stuttgart (DE)

(72) Inventors: Armin Schuelke, Aidlingen (DE); Friedrich Kneule, Rutesheim (DE)

(21) Appl. No.: 17/627,453

(22) PCT Filed: Jun. 25, 2020
(86) PCT No.: PCT/EP2020/067798

§ 371 Date: Jan. 14, 2022

(30) Foreign Application Priority Data
Jul. 17, 2019 (DE) 10 2019 210 515.7

(51) Int. Cl. F17C 13/04; H01M 8/04082

(52) U.S. Cl. CPC F17C 13/04; H01M 2250/20; F17C 2223/033; F17C 2223/035; F17C 2223/036; F17C 2201/0109; F17C 2203/066; F17C 2203/0646; F17C 2203/0663; F17C 2203/0639; F17C 2270/0168; F17C 2270/0184; F17C 2221/012; F17C 2209/228; F17C 2201/056; F17C 2203/0617; F17C 2209/234; F17C 2223/0123; H01M 8/04201

(57) ABSTRACT

The invention relates to a tank device (1) for storing a gaseous medium, in particular hydrogen, comprising at least one tank container (2), wherein said at least one tank container (2) has a tank housing (20) with a tank neck (3). In addition, a connection screw element (5) is arranged in the tank neck (3), wherein said connection screw element (5) is in contact with a conical sealing seat (10) formed on an inner face (8) of the tank housing (20), thereby sealing a tank neck interior (30) of the tank neck (3), and the connection screw element (5) can be pretensioned by means of a union nut element (6) attached to an outer face (9) of the tank housing (20).

### BACKGROUND

The invention relates to a tank device for a fuel cell tank, in particular for storing hydrogen, for example for use in vehicles with a fuel cell drive.

DE 10 2017 212 485 A1 describes a device for storing compressed fluids for a vehicle driven by means of gaseous fuels, wherein the device comprises at least two tubular tank modules and at least one high-pressure fuel distributor having at least one integrated control and safety device. The at least two tubular tank modules are connected modularly to the at least one high-pressure fuel distributor having the at least one integrated control and safety device to form a module of flexible geometry.

The safety devices for a tank device of this type are standardized. In this context, each tank device has to have, for example, a shut-off valve. Thus, the shut-off valve can ensure that the tank containers are closed if there is damage to the tank device caused by an accident involving the vehicle with a fuel cell drive or if there is a break in a line of the tank device, since the shut-off valves are closed in the currentless state. Thus, in the event of accidents and defects, it is always possible to avoid gas escaping from the tank containers.

Legal requirements stipulate that, depending on the container, these safety valves have to be attached directly to or even in the tank container. The safety valves are therefore directly exposed to the gaseous medium and to the system pressure, for example to system pressures of up to 1000 bar. These high forces acting on the safety valves require complicated structural measures to prevent damage to and therefore failure of the safety valves. Furthermore, the safety valves have to be protected against a possible “tearing off” during an accident.

### SUMMARY

By contrast, the tank device according to the invention has the advantage that, by mounting an additional structural component from the inner side of the tank device, the sealing of the tank device is significantly improved and a safety valve device which is integrated in the tank device is protected against damage.

For this purpose, the tank device for storing a gaseous medium, in particular hydrogen, has at least one tank container which has a tank housing with a tank neck. Furthermore, a connection screw element is arranged in the tank neck, which connection screw element lies against a conical sealing seat formed on an inner side of the tank housing and thus seals a tank neck interior of the tank neck. The connection screw element is pretensionable by means of a union nut element attached to an outer side of the tank housing.

Furthermore, the invention comprises a method for inserting the connection screw element into the tank neck of the tank container of the tank device. The connection screw element is inserted into the tank neck when the tank container has already been closed on the rear side by means of crimping, and a device is provided, with which device the connection screw element is placed from outside the interior of the tank container through the tank neck onto the sealing seat.

Improved sealing is obtained by the connection screw element in the tank neck of the tank container by the pressure in the interior of the tank container reinforcing the sealing effect. Furthermore, for example, “tearing off” of the valve device can be prevented since the latter is arranged in the tank container and said tank container withstands the pressure conditions in the event of an accident. Furthermore, the connection thread, which is formed in the tank housing, and is typically inserted in the interior of the tank neck can thus be dispensed with, and therefore there are no strength-reducing notches in the tank housing.

In a first advantageous development, it is provided that the connection screw element has a central opening, which opening is designed as a through bore. Advantageously, a valve device is accommodated in the opening of the connection screw element coaxially with respect to a longitudinal axis of the tank container and is connected fixedly to the connection screw element by means of screwing. The valve device can thus be integrated as a safety valve in the tank container in a structurally simple manner, wherein the valve device is protected from damage caused by external influences, such as, for example, shocks during operation. In addition, the flow of the gaseous medium out of the tank container can thus be controlled in a simple manner.

In an advantageous development, it is provided that the at least one tank container is configured for a differential pressure of 1 bar to 1000 bar in relation to atmospheric pressure. The use of the gaseous media in the tank container can thus be optimized.

In a further refinement of the invention, it is advantageously provided that the tank neck is cylindrical and merges as a conical widened portion into a cylindrical tank body, wherein a diameter d of the tank neck is smaller than a diameter D of the tank body. This shape permits a uniform distribution of pressure within the tank container.

In an advantageous development, the at least one tank container is produced from a plastics material, a carbon fiber material, aluminum, titanium, magnesium, a fiber material, in particular a glass fiber material, or steel. A cost-saving design of the tank container is thus obtained.

The tank device described is suitable preferably in a fuel cell arrangement for storing hydrogen for operating a fuel cell. Preferably, the tank device described can be used in a vehicle with a fuel cell drive.

### BRIEF DESCRIPTION OF THE DRAWINGS

Exemplary embodiments of a tank device according to the invention for storing a gaseous medium, in particular hydrogen, are illustrated in the drawing, in which

FIG. 1 shows an exemplary embodiment of a tank device according to the invention comprising a plurality of tank containers, comprising a tank housing with a tank neck and a tank body in longitudinal section,

FIG. 2 shows an enlarged detail of the exemplary embodiment in FIG. 1 in the region of the tank neck.

### DETAILED DESCRIPTION

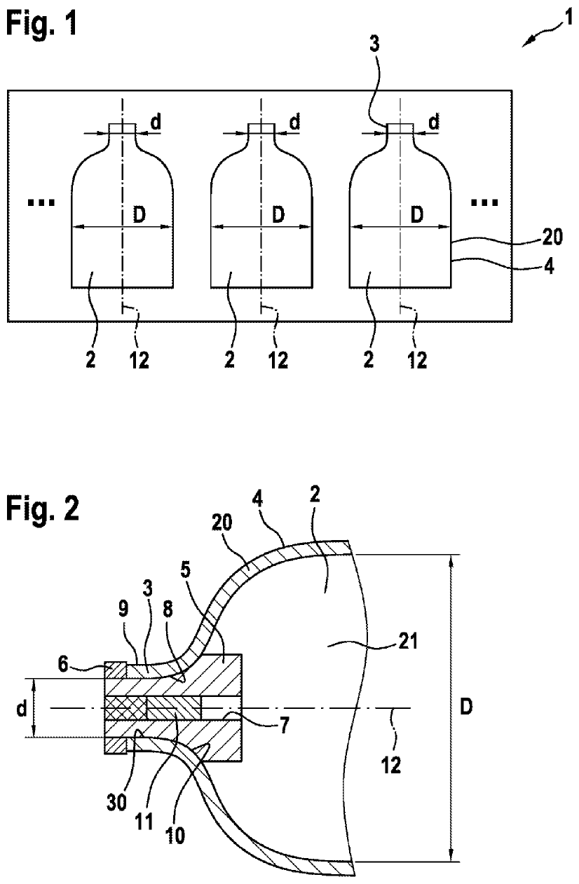

FIG. 1 shows an exemplary embodiment of a tank device 1 according to the invention for a gaseous medium, in particular hydrogen, in a schematic view. The tank device 1 has a multiplicity of tank containers 2 with a tank housing 20. The tank housing 20 comprises a tank body 4 and a tank neck 3 and has a longitudinal axis 12. The tank body 4 here is designed as a conical widened portion of the tank neck 3. Both the tank body 4 and the tank neck 3 are cylindrical, with the diameter D of the tank body 4 being larger than the diameter d of the tank neck 3.

FIG. 2 shows an enlarged view of the tank container 2 in the region of the tank neck 3 from FIG. 1 in cross section. The tank neck 3 has a tank neck interior 30 which opens into a tank interior 21 of the tank body 4.

A connection screw element 5 is arranged in the tank neck 3, said connection screw element lying against a conical sealing seat 10 which is formed on an inner side 8 of the tank housing 20. The tank neck interior 30 and also the tank interior 21 are thus sealed to the outside, and therefore no gaseous medium can flow out of the tank container 2. Furthermore, the connection screw element 5 is pretensioned by means of a union nut element 6 in the tank neck 3. The union nut element 6 here is attached to an outer side 9 of the tank housing 20.

Furthermore, an anti-twist device in the form of a hexagon socket is arranged on the tank container 2 in order to tighten the union nut element 6. This has the advantage that the connection screw element 5 does not rotate inward at the same time when the union nut element 6 is tightened.

Alternatively, other anti-twist devices may also be used, for example bores for the application of a pin wrench.

The connection screw element 5 has a central opening 7 which is designed as a through bore. A valve device 11 is accommodated in said opening 7 coaxially with respect to the longitudinal axis 12 of the tank container 2 and is connected fixedly to the connection screw element 5 by means of screwing.

The valve device 11 is typically activated electromagnetically and regulates the flow of gaseous medium, for example hydrogen, out of the tank container 2 toward, for example, an anode region of a fuel cell. In the unenergized state, the valve device 11 is closed since it is designed as a safety valve. It can thereby be ensured that, in the closed state and also in the event of accidents or defects, gas is always prevented from escaping from the tank containers 2.

The tank container 2 is configured for a differential pressure of 1 bar to 1000 bar in relation to atmospheric pressure. Typically, for example in the case of fuel cell arrangements, use is made of tank containers 2 which store hydrogen at a pressure of up to 700 bar. In addition, the tank container is produced from a plastics material, a carbon fiber material, aluminum, titanium, magnesium, a fiber material, in particular a glass fiber material, or steel.

The connection screw element 5 may be inserted, for example, at a time before the tank container 2 is closed on the rear side.

In an alternative method, the connection screw element 5 is joined into the tank neck 3 when the tank container 2 has already been closed on the rear side by means of crimping. Furthermore, a device is provided with which the connection screw element 5 is placed from outside the interior of the tank container 2 through the tank neck 3 onto the sealing seat 10. The fine machining of the sealing surface on the sealing seat 10 can take place here from a rear side of the tank container 2 or through the tank neck 3.

The tank device 1 can be used, for example, for storing hydrogen for the operation of a fuel cell or else can be integrated in vehicles with a fuel cell drive.

1. A tank device (1) for storing a gaseous medium, the tank device (1) comprising at least one tank container (2), which at least one tank container (2) has a tank housing (20) with a tank neck (3), wherein a connection screw element (5) is arranged in the tank neck (3), which connection screw element (5) lies against a conical sealing seat (10) formed on an inner side (8) of the tank housing (20) and seals a tank neck interior (30) of the tank neck (3), wherein the connection screw element (5) is pretensionable by a union nut element (6) attached to an outer side (9) of the tank housing (20).

2. The tank device (1) as claimed in claim 1, wherein the connection screw element (5) has a central opening (7), which opening (7) includes a through bore.

3. The tank device (1) as claimed in claim 2, wherein a valve device (11) is accommodated in the opening (7) of the connection screw element (5) coaxially with respect to a longitudinal axis (12) of the tank container (2) and is connected fixedly to the connection screw element (5) by screwing.

4. The tank device (1) as claimed in claim 1, wherein the at least one tank container (2) is configured for a differential pressure of 1 bar to 1000 bar in relation to atmospheric pressure.

5. The tank device (1) as claimed in claim 1, wherein the tank neck (3) is cylindrical and merges as a conical widened portion into a cylindrical tank body (4), wherein a diameter d of the tank neck (3) is smaller than a diameter D of the tank body (4).

6. The tank device (1) as claimed in claim 1, wherein the at least one tank container (2) is produced from a plastics material, a carbon fiber material, aluminum, titanium, magnesium, a fiber material, or steel.

7. A vehicle having a fuel cell drive and a tank device (1) as claimed in claim 1.

8. A fuel cell arrangement comprising a tank device (1) for storing hydrogen for operating a fuel cell as claimed in claim 1.

9. A method for inserting the connection screw element (5) into the tank neck (3) of the tank container (2) of a tank device (1) as claimed in claim 1, wherein the connection screw element (5) is inserted into the tank neck (3) when the tank container (2) has already been closed on a rear side by crimping, and a device is provided, with which device the connection screw element (5) is placed from outside the interior of the tank container (2) through the tank neck (3) onto the sealing seat (10).

10. The tank device (1) as claimed in claim 1, wherein the gaseous medium is hydrogen.

11. The tank device (1) as claimed in claim 6, wherein the at least one tank container (2) is produced from a glass fiber material.
